(19) United States
(12) Patent Application Publication
(10) Pub. No.: US 2024/0045739 A1
(43) Pub. Date: Feb. 8, 2024

(54) DYNAMIC API GATEWAY ROUTING IN RESPONSE TO BACKEND HEALTH METRICS

(71) Applicant: MORGAN STANLEY SERVICES GROUP INC., New York, NY (US)

(72) Inventors: Pradeep Sundaram, Princeton Junction, NJ (US); Shayan Shafizadeh, Great Neck, NY (US); Arnab Chatterjee, Bangalore (IN); Chandramouli Veebhudhi, Bangalore (IN)

(73) Assignee: MORGAN STANLEY SERVICES GROUP INC., New York, NY (US)

(21) Appl. No.: 17/883,334

(22) Filed: Aug. 8, 2022

(51) Int. Cl. G06F 9/54; G06F 9/445

(52) U.S. Cl. CPC G06F 9/541; G06F 9/44505

(57) ABSTRACT

A system and method for routing requests to an API to two or more API endpoints are disclosed. The system comprises at least a gateway router and a configuration server. When software is executed, the system transmits, from the configuration server to the gateway router, information setting a desired proportion of API requests to be allocated to each of the two or more API endpoints. When API requests are received, the gateway router forwards the API requests to the API endpoints in the desired proportion. The system receives metrics data from one or more backend entities upon which at least one of the API endpoints relies for data or other services, and determines that an adverse event is underway or imminent based at least in part on the received metrics data. In response to the event, it forwards the API requests in a second proportion different from the desired proportion.

### FIELD OF INVENTION

This disclosure relates to systems and methods for routing network-based requests to invoke an application programming interface (API), and more specifically, to systems and methods for balancing incoming API requests from client computing devices and routing them to a number of server computing devices during changes in health of a backend system upon which the servers rely.

### BACKGROUND

When a website, domain, organization, or other entity provides a web-based application programming interface (API) to a number of clients, partners, other associates, or members of the public, it is common to have a cluster of servers running substantially identical software share in performing whatever actions or queries are being requested by the API. The load of incoming requests may be balanced by a gateway router that decides which server to forward a request to based on simplistic algorithms like “round robin” assignment in sequential order, or more sophisticated ones such as selecting the server currently having the least CPU utilization. Efficient selection and forwarding makes the API much more robust against failure due to unexpected system loads or denial of service attacks, and decreases the average latency of the API. Use of the gateway router can also hide the network topology of the servers behind the router, improving security and flexibility to make changes behind the router without needing to change configurations on the client side.

If one server in a cluster becomes non-responsive or suffers a loss of functionality for any reason, but the gateway router is not aware of it, there is a danger that the router will continue to forward API messages to that server. Upon failing to receive a response from the server, receiving a nonsensical response from the server, or otherwise having an unsatisfactory outcome, a client who had interacted with the server may make one or more repeated attempts to invoke the API. The router may continue to forward traffic to the malfunctioning server, may further burden the other servers by allowing these repeated requests to build up and cascade, and services relying on prompt API responses may suffer.

Thus, there are advantages to having a system that anticipates server malfunctions or other detrimental network conditions before they occur and that shifts incoming traffic between multiple servers to maintain API responsiveness.

### SUMMARY OF THE INVENTION

Presently disclosed are a system and method for making more sophisticated routing decisions and improving the responsiveness of an API to client requests. The routing decisions are based not only on first-order considerations such as the present workload or CPU utilization of each server, but also on second-order considerations external to each server, such as possible latency or errors that will be introduced by dependencies of that server, including databases providing data for a server, other secondary servers performing computations or queries needed by a primary server, or credentialing or security servers whose authorization or participation is required before the server will permit the client to receive the response.

The presently-described system allows an API provider to dynamically and intelligently route traffic based on health metrics published by various backend services, and to select which health metrics will be monitored and utilized in making routing decisions if the metrics begin to exceed predefined thresholds or thresholds set as normal based on prior statistical analysis. Decisions may be specified by human users in advance and then automatically implemented when an anomaly occurs, for maximum efficiency and responsiveness of the API.

If an API has a Service Level Agreement (SLA), proactively responding to re-route traffic based on second-order considerations before a server begins exhibiting first-order behavior changes helps to ensure that the system remains in compliance with the SLA. A momentary lapse in server functionality from an upstream problem is much less likely to affect the downstream API endpoints and trigger an SLA violation when clients fail to receive expected functionality from those endpoints.

A system and method for routing requests to an API to two or more API endpoints are disclosed. The system comprises at least a gateway router and a configuration server. When software is executed, the system transmits, from the configuration server to the gateway router, information setting a desired proportion of API requests to be allocated to each of the two or more API endpoints. When API requests are received, the gateway router forwards the API requests to the API endpoints in the desired proportion. The system receives metrics data from one or more backend entities upon which at least one of the API endpoints relies for data or other services, and determines that an adverse event is underway or imminent based at least in part on the received metrics data. In response to the event, it forwards the API requests in a second proportion different from the desired proportion.

Additional features include variations of the above system and method wherein
after determining that the adverse event has resolved based at least in part on the received additional metrics data the API requests are forwarded to the two or more API endpoints in a third proportion different from the second proportion, which may be the same as or different from the original desired proportion;
the forwarding of API requests may be probabilistic or deterministic;
the forwarding of a particular API request is based at least in part on credentials available to a client who initiated the particular API request; and
the determination that an adverse event is underway or imminent is based at least in part on data staleness in one of the one or more backend entities, on unacceptably high latency in one of the one or more backend entities, on an anticipated failure to satisfy a service level agreement, and/or on receiving a message from custom-written software operating on one of the one or more backend entities.

### BRIEF DESCRIPTION OF THE DRAWINGS

Other aspects, features and advantages will become more fully apparent from the following detailed description, the appended claims, and the accompanying drawings (provided solely for purposes of illustration without restricting the scope of any embodiment), of which:

FIG. 1 illustrates, in simplified form, a system of computing devices used in providing an API to one or more client devices contacting a gateway with servers behind the gateway;

FIG. 2 illustrates an example user interface to be used in setting traffic routing parameters between two possible API endpoints;

FIG. 3 illustrates an example user interface to be used to modify the traffic routing parameters between the two possible API endpoints during an ongoing situation and after its resolution;

FIG. 4 illustrates, in simplified form, a method for receiving backend health information and updating routing information at a gateway; and

FIG. 5 is a high-level block diagram of a representative computing device that may be utilized to implement various features and processes described herein.

### DETAILED DESCRIPTION

As previously mentioned, in order to address the problem of routers making a decision to reroute traffic only when it is too late and server functionality or responsive is already suffering, a system may be configured instead to make decisions proactively, before a server is affected, based on irregularities or problems noted with the various backend dependencies that a server relies upon.

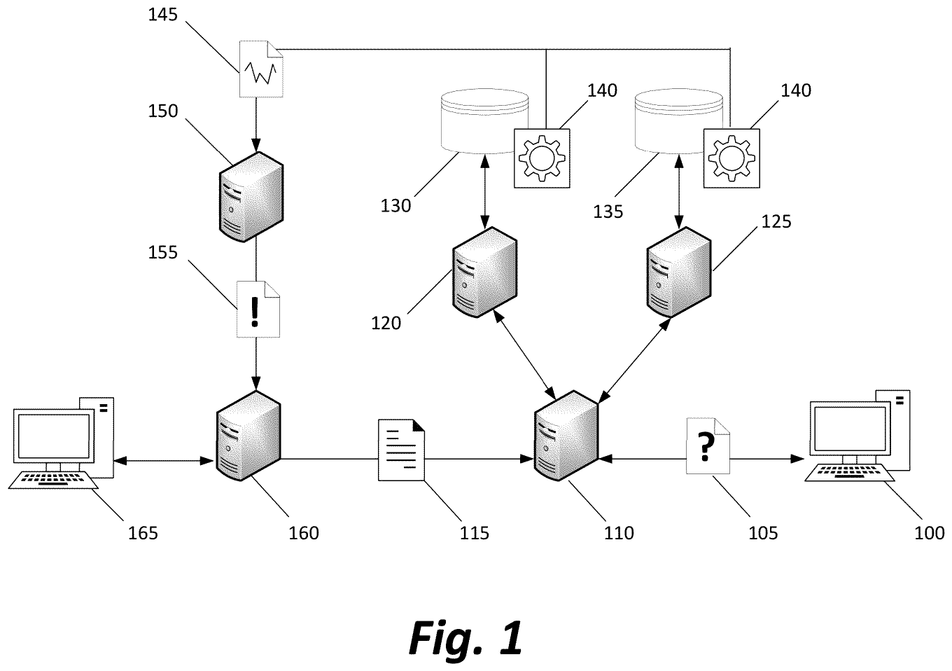

FIG. 1 illustrates, in simplified form, a system of computing devices used in providing an API to one or more client devices contacting a gateway with servers behind the gateway.

As depicted in FIG. 1, software operating on a client computer 100 may make a request or query 105 to an API gateway 110 that acts as the external face of the overall system providing the API. The gateway 110 stores a configuration file 115 that describes a desired routing behavior, described in further detail below. With some probability between 0% and 100% inclusive, a request from the client computer 100 will be forwarded to a first API endpoint 120, and with a corresponding probability between 100′% and 0% inclusive, the request will instead by forwarded to a second API endpoint 125.

Although the examples in this disclosure all concern systems having two API endpoints 120 and 125, there is no inherent limit to only two endpoints, and instead, three or more endpoints might be used instead, so long as the sum of the probabilities remains at 100%.

Each of the endpoints 120 and 125 connects to one or more backend services 130 and 135, such as a database that stores data needed for the endpoint to query the data and provide it in some format to the requestor. Further, operating on a same computing device as each of the backend services 130 and 135 is a software library, module, or thread 140 for gathering various data metrics 145 representing the utilization, functionality, and health of the backend service.

The software 140 continually transmits updated metrics data 145 to a monitoring server 150. In a preferred embodiment, this server may be operating the Prometheus open source system for metrics collection and alert generation, though any other generally available software or custom software for statistical analysis may be used instead.

Whenever the incoming metrics 145 indicate that one of the backend services may be experiencing a problem, an alert 155 is generated by the monitoring server and transmitted to a configuration server 160. The existence of a problem justifying an alert may be set by a predetermined metric value, such as a latency of greater than one millisecond or a data staleness of greater than two seconds in a system that is always expecting data to be refreshed on a millisecond-by-millisecond basis. A problem might also be indicated by a statistically abnormal status, such as any metric having a value more than N standard deviations different from its historical mean, for some value N. A problem might also be indicated by a metric that indicates a service level agreement will no longer be likely to be met, such as a server outage of more than one millisecond in a system that promises “five nines” uptime, or a latency in the backend service that represents a significant fraction of a promised maximum latency for the API endpoint that depends upon it. Other metrics such as CPU utilization, number of concurrent connections, total data throughput, number of threads being operated, number of logged errors, or types or codes of logged errors might be used in determining that an anomaly exists and justifies an alert. Any operator of the system may create any number of custom metrics of any nature that may be predictive of a current or future problem in the API endpoint functionality.

Upon receiving the alert 155, the configuration server 160 may consult a number of stored expected alerts and predetermined responses to those alerts in the form of new routing behavior to the two endpoints 120 and 125. If a matching alert and response are found, a new configuration 115 is sent to the gateway 110, causing a change in its routing behavior. When the alert is resolved because the data metrics are no longer critically abnormal, yet another configuration 115 may be sent to the gateway instructing it to return to the original routing behavior, or to a third routing behavior different from the original and temporary behaviors.

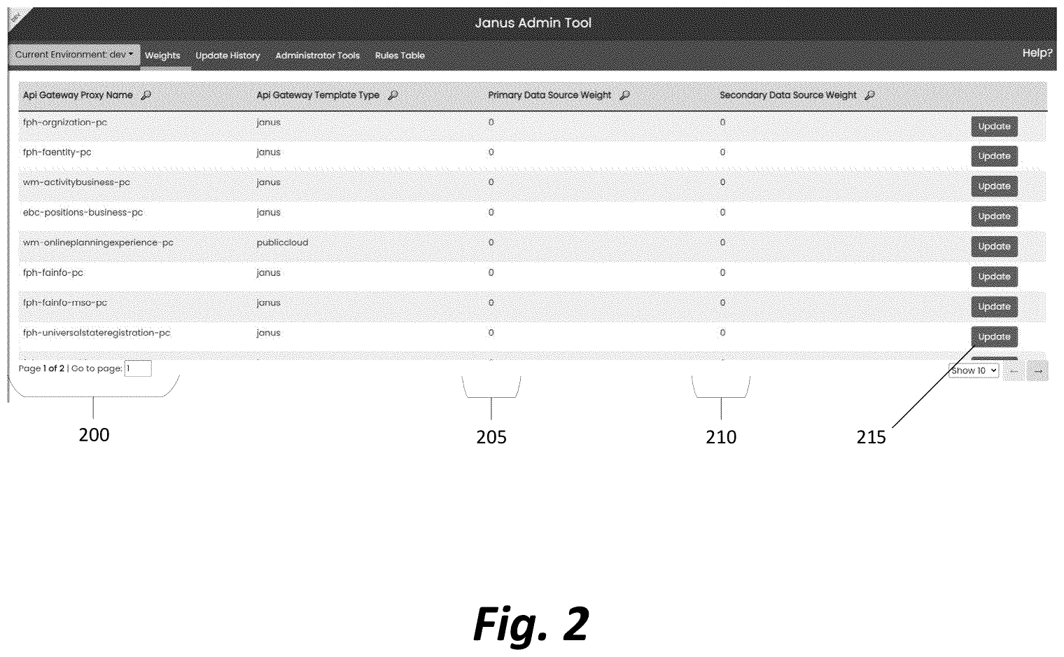

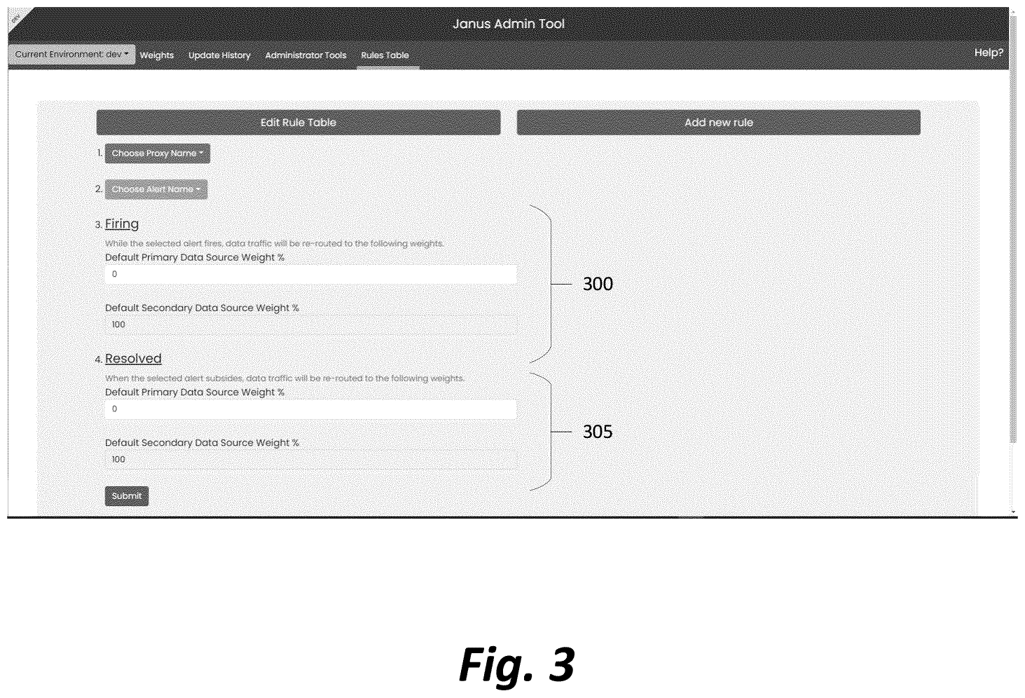

The original, temporary, and optional third routing configurations 115 may all be specified using a user interface operated by a human user of a configuration client computing device 165. Examples from this user interface are depicted in FIGS. 2 and 3 and discussed further below.

Although a particular division of functions between devices is described with relation to the systems depicted in FIG. 1, above, other configurations are possible in which functions are divided among devices differently. For example, all of the functions of some or all of the monitoring server 150, configuration server 160, and configuration client 165 could all be performed by a single computing device with multiple threads executing different software modules simultaneously, or the functionality of the client computing device 100 and the gateway router 110 could be combined into a single device that forwards a number of requests to different destinations based on the configuration.

Alternatively, each system or device may in fact be a cluster of computing devices sharing functionality for concurrent processing. Further, although these various computing elements are described as if they are one computing device or cluster each, a cloud-based solution with multiple access points to similar systems that synchronize their data and are all available as backups to one another may be preferable in some embodiments to a unique set of computing devices all stored at one location. The specific number of computing devices and whether communication between them is network transmission between separate computing devices or accessing a local memory of a single computing device is not so important as the functionality that each part has in the overall scheme.

FIG. 2 illustrates an example user interface to be used in setting traffic routing parameters between two possible API endpoints.

For each of a series of APIs 200, a primary backend weight 205 and a secondary backend weight 210 are stored, preferably in the form of a percentage. As previously mentioned, this represents a gateway router policy of forwarding a request to the first endpoint 110 with a first predetermined probability, and to the second endpoint 115 with a corresponding remainder probability. In some embodiments, rather than being a true independent probability, there may be deterministic factors that affect the decision for reasons of efficiency or security.

For example, rather than actually generate random numbers, an API with a 90/10 division between the primary and secondary endpoints might have the gateway forward every tenth request to the secondary gateway, while the remainder of requests are forwarded to the primary gateway. In another embodiment, some client computers may have necessary credentials to access a different endpoint from other client computers that are operated by uncredentialed members of the public. In this scenario, credentialed requests might always be forwarded to the primary endpoint and uncredentialed requests to the secondary endpoint, but the secondary endpoint remains a backup option even for credentialed requests if the backend services the primary endpoint relies on are overtaxed or unavailable.

Upon clicking an “Update” button 215 for any given API 200, a popup menu appears, allowing the user to set two new weightings 205 and 210 that sum to 100%.

The weights 205 and 210 represent the default divisions of traffic that will occur so long as no situations affect the backend services and force a new re-allocation of requests to the two endpoints. FIG. 3 depicts how that re-allocation may be customized.

FIG. 3 illustrates an example user interface to be used to modify the traffic routing parameters between the two possible API endpoints during an ongoing situation and after its resolution.

In another tab of the same interface depicted in FIG. 2, a particular alert may be specified for a particular API/API endpoint. After specifying the alert to be listening for and which will be responded to, weightings of API traffic may be specified for during and after the alert.

So long as the alert is still “firing” and the situation persists, a first pair of weightings 300 will define the allocation of incoming traffic between the primary and secondary endpoints. When the event has been resolved and the alert is no longer being sent, a second pair of weightings 305 will define the allocation of incoming traffic between the primary and secondary endpoints. This second pair of weightings may be identical to the weightings 205 and 210 that were the defaults before the event fired, but they may alternatively be configured to be different if a different behavior is desired in the aftermath of a potential loss of server functionality.

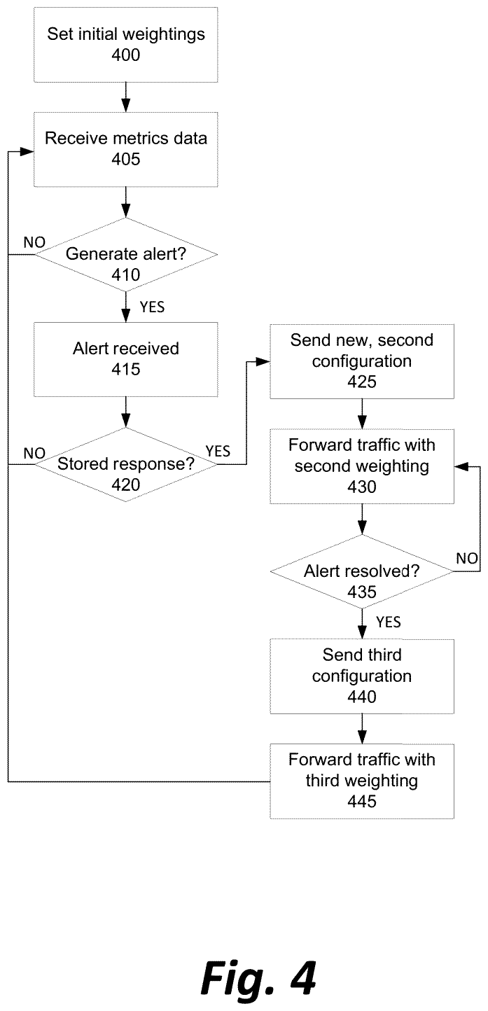

FIG. 4 illustrates, in simplified form, a method for receiving backend health information and updating routing information at a gateway.

First, initial weightings are set between the two or more endpoints for each API (Step 400). In some embodiments, these weightings may be 100% and 0% respectively, representing that the second API endpoint is exclusively used as a backup in case of system failure. In other embodiments, the weightings may be heavily imbalanced, such as 99/1, 96/4, or 90/10, but not a 100/0 division. This may help ensure that some requests are still sent to each API endpoint, preventing any API endpoint from excessive idling, processes being archived, and so on.

The monitoring server routinely receives metric data from the backend services (Step 405) and evaluates, based on criteria previously described above, whether cause exists that justifies sending an alert (Step 410).

If an alert is sent to the configuration server (Step 415), the configuration server looks for a stored response to the alert (Step 420). If that response exists, a new configuration is sent to the gateway (Step 425). If no predetermined response to the alert exists, the configuration server may generate a message to a human user indicating that a manual response may be desirable, and return to receiving metric data in case a second alert is generated (back to Steps 405 and 410).

The gateway continues to forward API traffic (Step 430) in accordance with the temporary weighting so long as the alert persists (Step 435). If the alert is resolved, the stored post-alert response (see FIG. 3) is retrieved, and the original or third weighting is transmitted to the gateway (Step 440); otherwise the second, temporary weighting continues to be used (back to Step 430). The gateway then continues to forward traffic (Step 445) until another alert is triggered (back to Steps 405 and 410) or until the automated loop is short-circuited by a human user directly specifying new weightings (see FIG. 2).

Generalized Computing Devices

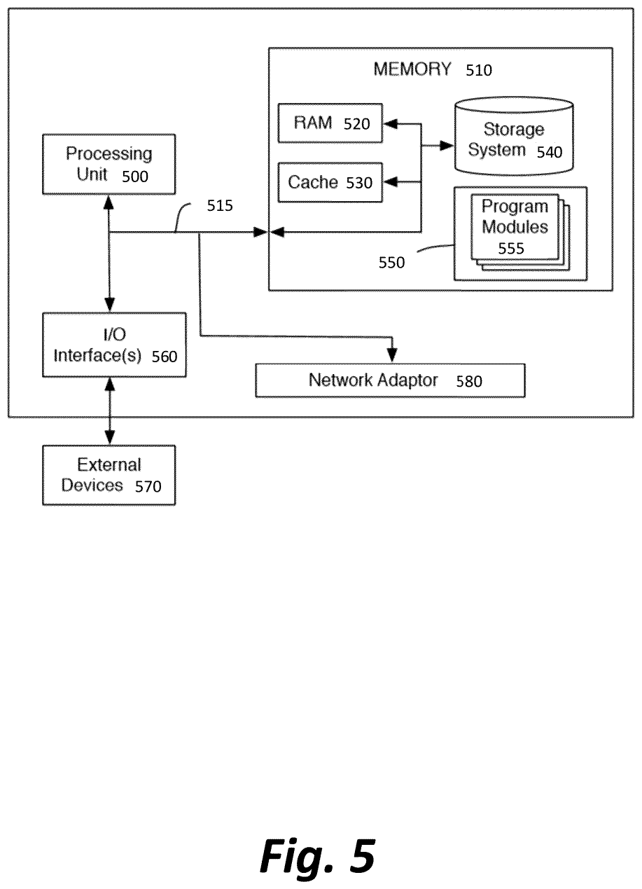

The method described herein and the system depicted in FIG. 1 may preferably use certain specialized hardware, such as a dedicated router for the gateway 105. However, the disclosed method and system do not inherently rely on the use of any particular specialized computing devices, as opposed to standard desktop computers and/or web servers. For the purpose of illustrating possible such computing devices, FIG. 5, below, describes various enabling devices and technologies related to the physical components and architectures described above.

FIG. 5 is a high-level block diagram of a representative computing device that may be utilized to implement various features and processes described herein, for example, the functionality of the client computing device 100, the gateway 110, the endpoints 120 and 125, the services 130 and 135, the monitoring server 150, the configuration server 160, and the configuration client 165, or any other computing device described. The computing device may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 5, the computing device is illustrated in the form of a special purpose computer system. The components of the computing device may include (but are not limited to) one or more processors or processing units 500, a system memory 510, and a bus 515 that couples various system components including memory 510 to processor 500.

Bus 515 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Processing unit(s) 500 may execute computer programs stored in memory 510. Any suitable programming language can be used to implement the routines of particular embodiments including C, C++, Java, assembly language, etc. Different programming techniques can be employed such as procedural or object oriented. The routines can execute on a single computing device or multiple computing devices. Further, multiple processors 500 may be used.

The computing device typically includes a variety of computer system readable media. Such media may be any available media that is accessible by the computing device, and it includes both volatile and non-volatile media, removable and non-removable media.

System memory 510 can include computer system readable media in the form of volatile memory, such as random access memory (RAM) 520 and/or cache memory 530. The computing device may further include other removable/non-removable, volatile/non-volatile computer system storage media. By way of example only, storage system 540 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 515 by one or more data media interfaces. As will be further depicted and described below, memory 510 may include at least one program product having a set (e.g., at least one) of program modules that are configured to carry out the functions of embodiments described in this disclosure.

Program/utility 550, having a set (at least one) of program modules 555, may be stored in memory 510 by way of example, and not limitation, as well as an operating system, one or more application software, other program modules, and program data. Each of the operating system, one or more application programs, other program modules, and program data or some combination thereof, may include an implementation of a networking environment.

The computing device may also communicate with one or more external devices 570 such as a keyboard, a pointing device, a display, etc.; one or more devices that enable a user to interact with the computing device; and/or any devices (e.g., network card, modem, etc.) that enable the computing device to communicate with one or more other computing devices. Such communication can occur via Input/Output (I/O) interface(s) 560.

In addition, as described above, the computing device can communicate with one or more networks, such as a local area network (LAN), a general wide area network (WAN) and/or a public network (e.g., the Internet) via network adaptor 580. As depicted, network adaptor 580 communicates with other components of the computing device via bus 515. It should be understood that although not shown, other hardware and/or software components could be used in conjunction with the computing device. Examples include (but are not limited to) microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may use copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in tact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for routing requests to an API to two or more API endpoints, comprising:
a gateway router;
a configuration server; and
non-transitory memory comprising instructions that, when executed by one or more processors, cause the one or more processors to:
transmit, from the configuration server to the gateway router, information setting a desired proportion of API requests to be allocated to each of the two or more API endpoints;
upon receiving API requests at the gateway router, forward the API requests to the two or more API endpoints in the desired proportion;
identify one or more servers that are dependencies for the two of more API endpoints with respect to the API requests, because the API requests cannot be satisfied without data retrieved from, computations performed by, or credentials provided by the one or more servers;
receive second-order metrics from the one or more servers, concerning ability of the one or more servers to timely and accurately provide data stored by them, wherein the second-order metrics include data staleness of data stored by the one or more servers, measured in time since data was last updated, and at least one of: CPU utilization in the one or more servers, number of concurrent connections to the one or more servers, and total data throughput from the one or more servers,
determine that an adverse event is underway or imminent based at least in part on the received second-order metrics before a degradation in responsiveness of either of the two or more API endpoints has been identified, such that the adverse event will degrade responsiveness of at least one of the two or more API endpoints if no action is taken; and
in response to the determined adverse event, forward the API requests to the two or more API endpoints in a second proportion different from the desired proportion.

2. The system of claim 1, wherein the instructions, when executed by one or more processors, further cause the one or more processors to:
subsequent to determining that the adverse event is underway or imminent, receive additional second-order metrics from the one or more servers;
determine that the adverse event has resolved based at least in part on the received additional second-order metrics; and
in response to the determined resolution of the adverse event, forward the API requests to the two or more API endpoints in a third proportion different from the second proportion.

3. The system of claim 2, wherein the third proportion is an identical proportion to the desired proportion.

4. The system of claim 1, wherein the forwarding of API requests is probabilistic.

5. The system of claim 1, wherein the forwarding of API requests is deterministic.

6. The system of claim 1, wherein the forwarding of a particular API request is based at least in part on credentials available to a client who initiated the particular API request.

7-9. (canceled)

10. The system of claim 1, wherein the determination that an adverse event is underway or imminent is based at least in part on, after the system has begun to forward API requests, receiving custom-written software by an operator of the system, such that the custom-written software is executed on at least one of the one or more servers to monitor and analyze performance of an API for second-order metrics specific to that API, executing the custom-written software, and receiving a message from the custom-written software.

11. A computer-implemented method for routing requests to an API to two or more API endpoints, comprising:
transmitting, from a configuration server to a gateway router, information setting a desired proportion of API requests to be allocated to each of two or more API endpoints;
upon receiving API requests at the gateway router, forwarding the API requests to the two or more API endpoints in the desired proportion;
identifying one or more servers that are dependencies for the two of more API endpoints with respect to the API requests, because the API requests cannot be satisfied without data retrieved from, computations performed by, or credentials provided by the one or more servers;
receiving second-order metrics from the one or more servers, concerning ability of the one or more servers to timely and accurately provide data stored by them, wherein the second-order metrics include data staleness of data stored by the one or more servers measured in time since data was last updated, and at least one of: CPU utilization in the one or more servers;
determining that an adverse event is underway or imminent based at least in part on the received second-order metrics before a degradation in responsiveness of either of the two or more API endpoints has been identified, such that the adverse event will degrade responsiveness of at least one of the two or more API endpoints if no action is taken; and
in response to the determined adverse event, forwarding the API requests to the two or more API endpoints in a second proportion different from the desired proportion.

12. The method of claim 11, further comprising:
subsequent to determining that the adverse event is underway or imminent, receiving additional second-order metrics from the one or more servers;
determining that the adverse event has resolved based at least in part on the received additional second-order metrics; and
in response to the determined resolution of the adverse event, forwarding the API requests to the two or more API endpoints in a third proportion different from the second proportion.

13. The method of claim 12, wherein the third proportion is an identical proportion to the desired proportion.

14. The method of claim 11, wherein the forwarding of API requests is probabilistic.

15. The method of claim 11, wherein the forwarding of API requests is deterministic.

16. The method of claim 11, wherein the forwarding of a particular API request is based at least in part on credentials available to a client who initiated the particular API request.

17-19. (canceled)

20. The method of claim 11, wherein the determination that an adverse event is underway or imminent is based at least in part on, after the system has begun to forward API requests, receiving custom-written software by an operator of the system, such that the custom-written software is executed on at least one of the one or more servers to monitor and analyze performance of an API for second-order metrics specific to that API, executing the custom-written software, and receiving a message from the custom-written software.

21-25. (canceled)
